(19) United States
(12) Patent Application Publication
(10) Pub. No.: US 2024/0179691 A1
(43) Pub. Date: May 30, 2024

(54) TERMINAL DEVICE, BASE STATION DEVICE, AND COMMUNICATION METHOD, AND COMPUTER-READABLE STORAGE MEDIUM FOR LOW-LATENCY TIME DIVISION COMMUNICATION

(71) Applicant: KDDI CORPORATION, Tokyo (JP)

(72) Inventors: Masahito UMEHARA, Tokyo (JP); Masaya SHIBAYAMA, Tokyo (JP)

(21) Appl. No.: 18/429,764

(22) Filed: Feb. 1, 2024

Related U.S. Application Data
(63) Continuation of application No. PCT/JP2022/025817, filed on Jun. 28, 2022.

(30) Foreign Application Priority Data
Aug. 11, 2021 (JP) 2021-131327

(51) Int. Cl. H04W 72/0446; H04L 5/14; H04W 72/232; H04W 76/20

(52) U.S. Cl. CPC H04W 72/0446; H04L 5/1469; H04W 72/232; H04W 76/20

(57) ABSTRACT

A terminal device performs setting so that a timeslot allocation is switched, in units of time slots, between a first allocation and a second allocation different from the first allocation, the first allocation and the second allocation being allocation of a time slot in which uplink communication is performed and a time slot in which downlink communication is performed in time division duplex (TDD) communication, and performs communication with a base station device based on the setting.

### CROSS-REFERENCE TO RELATED APPLICATION(S)

This application is a continuation of International Patent Application No. PCT/JP2022/025817 filed on Jun. 28, 2022, which claims priority to and the benefit of Japanese Patent Application No. 2021-131327 filed on Aug. 11, 2021, the entire disclosures of which are incorporated herein by reference.

### BACKGROUND OF THE INVENTION

### Field of the Invention

The present invention relates to a technology for reducing delay in wireless communication in a cellular communication system.

### Description of the Related Art

Low-latency communication is required in a cellular communication system, and the 3rd Generation Partnership Project (3GPP (registered trademark)) has been conducting technical studies in order achieve ultra-reliable and low-latency communication (URLLC).

An object of the present invention is to provide a technology for reducing delay in wireless communication in a cellular communication system.

### SUMMARY OF THE INVENTION

According to one aspect of the present invention, there is provided a terminal device comprising: one or more processors; and one or more memories that stores a computer-readable instruction for causing, when executed by the one or more processors, the one or more processors to function as: a setting unit configured to perform setting so that a timeslot allocation is switched, in units of time slots, between a first allocation and a second allocation different from the first allocation, the first allocation and the second allocation being allocation of a time slot in which uplink communication is performed and a time slot in which downlink communication is performed in time division duplex (TDD) communication; and a communication unit configured to perform communication with a base station device based on the setting.

According to another aspect of the present invention, there is provided a base station device comprising: one or more processors; and one or more memories that stores a computer-readable instruction for causing, when executed by the one or more processors, the one or more processors to function as: a setting unit configured to perform setting of a terminal device so that a timeslot allocation is switched, in units of time slots, between a first allocation and a second allocation different from the first allocation, the first allocation and the second allocation being allocation of a time slot in which uplink communication is performed and a time slot in which downlink communication is performed in time division duplex (TDD) communication; and a communication unit configured to perform communication with the terminal device based on the setting.

Further features of the present invention will become apparent from the following description of exemplary embodiments with reference to the attached drawings.

### BRIEF DESCRIPTION OF THE DRAWINGS

FIG. 1 is a diagram showing an example of a configuration of a wireless communication system.

FIG. 2 is a diagram showing an example of allocation of resources to uplink and downlink communication.

FIG. 3 is a diagram showing an example of a flow of communication executed by a terminal device according to an embodiment.

FIG. 4 is a diagram showing an example of a hardware configuration of a base station device and the terminal device.

FIG. 5 is a diagram showing an example of a functional configuration of the base station device.

FIG. 6 is a diagram showing an example of a functional configuration of the terminal device.

FIG. 7 is a diagram illustrating an example of a flow of processing executed in the wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration of Communication System

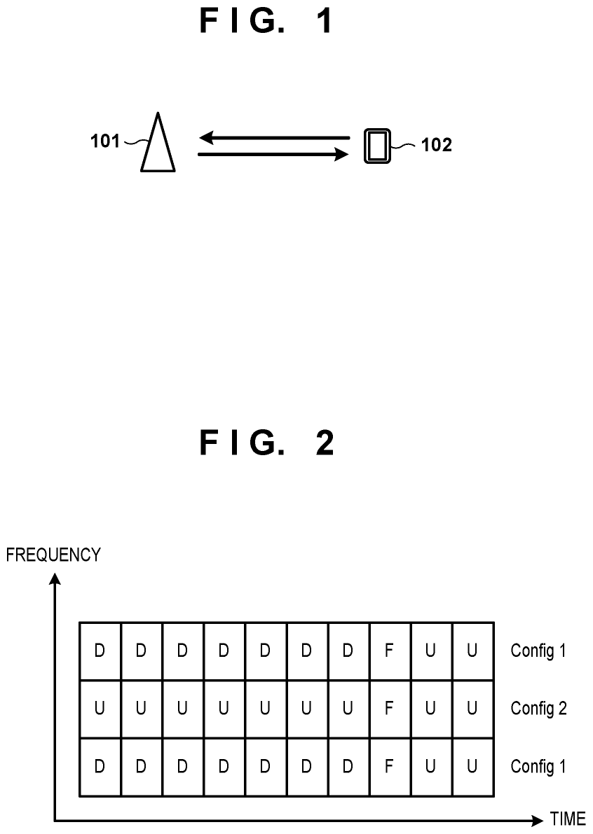

FIG. 1 shows an example of the configuration of a wireless communication system according to the present embodiment. This wireless communication system is a wireless communication system that complies with the fifth generation (5G) cellular wireless communication standard defined by the 3rd Generation Partnership Project (3GPP (registered trademark)), for example. Note that this is merely one example, and other wireless communication systems may be used. This wireless communication system includes a base station device 101 and a terminal device 102, for example. Note that although FIG. 1 shows only one base station device and one terminal device in order to simplify the description, there of course may be many base station devices and many terminal devices.

In the wireless communication system, time division duplex (TDD) is used for communication between the base station device 101 and the terminal device 102. With TDD, a common frequency resource is divided into time slots/subframes, and the time slots/subframes are each allocated to the uplink (the link in the direction from the terminal device 102 to the base station device 101) or the downlink (the link in the direction from the terminal device 102 to the base station device 101). This allocation corresponds to “TDD Configuration” in Long Term Evolution (LTE) and 5G. Note that hereinafter, a time resource having a fixed time width, such as a time slot or a subframe, will be referred to as a time slot.

In communication, reliability can be improved using a hybrid automatic repeat request (HARQ), for example. For example, in the case of using a HARQ in downlink communication, the terminal device 102 receives user data in a time slot allocated to the downlink and then transmits an acknowledgment response (ACK/NACK) in a time slot allocated to the uplink, and the base station device 101 can execute processing such as retransmission based on the acknowledgment response. Also, in the case of using a HARQ in uplink communication, the base station device 101 receives user data in a time slot allocated to the uplink and then transmits an acknowledgment response in a time slot allocated to the downlink, and the terminal device 102 can execute processing such as retransmission based on the acknowledgment response. In this way, in communication, a combination of uplink communication and downlink communication can be used. A combination of uplink communication and downlink communication is also used in a random access procedure performed when the terminal device 102 connects to the base station device 101. When performing uplink communication as well, a combination of uplink communication and downlink communication is used in procedures such as scheduling requests and buffer status reports.

In the case where a combination of uplink communication and downlink communication is used in this way in a TDD system, when a downlink signal is transmitted and then an uplink signal needs to be transmitted for example, the terminal device 102 needs to wait for arrival of the timing allocated to the uplink. Similarly, when an uplink signal is to be transmitted and then a downlink signal needs to be transmitted for example, the base station device 101 needs to wait for arrival of the timing allocated to the downlink. At this time, if many time slots have been allocated to downlink communication, for example, it may take a long time for an uplink signal to be transmitted in response to the downlink signal due to the small number of uplink time slots. Similarly, if a large number of time slots have been allocated to uplink communication, for example, it may take a long time for a downlink signal to be transmitted in response to the uplink signal due to the small number of downlink time slots.

In view of this, in the present embodiment, instead of using the same TDD setting (pattern of allocation of time slots to uplink and downlink) for the entire frequency band as in conventional technology, different TDD settings are used in portions of the frequency band as shown in FIG. 2. As one specific example, a plurality of different patterns of time slot allocation for uplink communication and downlink communication, which differ depending on the range of frequency resources, are used in a certain frequency band that can be used for communication by the terminal device 102. When performing communication, the terminal device 102 sets an allocation pattern by switching the allocation pattern between the allocation patterns, and performs uplink or downlink communication based on the set pattern.

FIG. 2 shows a state in which a first allocation pattern (Config 1) is used in frequency domains shown at the top and the bottom, and a second allocation pattern (Config 2) is used in the frequency domain therebetween. In this example, in the first allocation pattern, a majority of the time slots are allocated to downlink communication, whereas in the second allocation pattern, a majority of the time slots are allocated to uplink communication. On the other hand, even in the case where allocation is performed in this way, conventionally, the terminal device 102 does not switch between allocation patterns (Config) within one frame. For this reason, in the example of using the first allocation pattern, upon receiving data in the first downlink time slot for example, the terminal device 102 needs to wait for arrival of the ninth time slot in order to transmit a response. Also, in the case where the terminal device 102 uses the second allocation pattern, there is no downlink time slot, and therefore downlink communication cannot be performed.

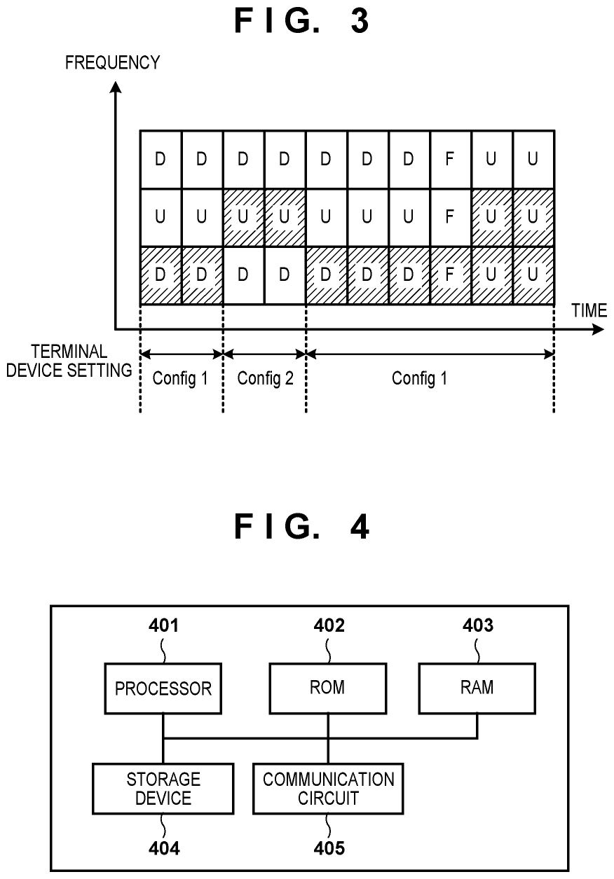

In the present embodiment, the terminal device 102 switches between allocation patterns (Config) within one frame (e.g., performs switching in units of time slots or units of subframes). For example, as shown in FIG. 3, the terminal device 102 uses the first allocation pattern to perform downlink communication in the first two time slots, and then uses the second allocation pattern to perform uplink communication in the two subsequent time slots. According to this configuration, if user data is received in the second time slot for example, the terminal device 102 can transmit an acknowledgment response in the third time slot. The terminal device 102 then switches back to the first allocation pattern, and can then receive downlink user data. Note that the allocation of resources to the terminal device 102 can be performed over the entirety of a frequency band in which multiple allocation patterns are mixed. Therefore, when user data is transmitted in a frequency resource in which the first allocation pattern is used, a frequency resource in which the second allocation pattern is used can be designated as a frequency resource for an acknowledgment response for such user data. Also, when user data is to be transmitted on the uplink, for example, a combination of a frequency resource in which the first allocation pattern is used and a frequency resource in which the second allocation pattern is used can be allocated to the terminal device 102, as shown in the ninth and tenth time slots in FIG. 3.

According to this configuration, the terminal device 102 can execute low-latency communication by utilizing a plurality of patterns of time slot allocation for uplink communication and downlink communication, which are set for different frequency resources in the system. For example, in the case where only the first allocation pattern described above is used, downlink data and an acknowledgment response for the downlink data can be transmitted and received one time each in one frame (ten time slots). On the other hand, as shown in FIG. 3, by switching between the first allocation pattern and the second allocation pattern when performing communication, it is possible perform communication in which, for example, first downlink user data is transmitted and received in the first time slot, then a corresponding acknowledgment response is transmitted and received in the third time slot, then second downlink user data is transmitted and received in the sixth time slot, and then a corresponding acknowledgment response is transmitted and received in the ninth time slot. In this way, by switching between a plurality of allocation patterns, a combination of user data and an acknowledgment response can be transmitted and received more times. Also, by switching between a plurality of allocation patterns, it is possible to increase the number of times that a combination of an uplink signal and a downlink signal can be transmitted and received within a certain period of time, thus making to possible to also shorten the time taken to complete a procedure that requires a plurality of exchanges of signals, such as SR and BSR transmission, for the transmission and reception of uplink data. Furthermore, the terminal device 102 can switch between a plurality of allocation patterns in a random access procedure. For example, the terminal device 102 can transmit a random access preamble (Message 1) using the second allocation pattern, and then switch to the first allocation pattern and receive a random access response (Message 2). The terminal device 102 can then transmit a Message 3 using the second allocation pattern, and receive a Message 4 using the first allocation pattern. As a result, the time taken to complete the random access procedure can be shortened, and the terminal device 102 can connect to the base station device 101 in a shorter time.

The base station device 101 can set the allocation patterns that are to be used by the terminal device 102 by transmitting, to the terminal device 102, information indicating which allocation pattern is to be used by the terminal device 102 in each time slot. For example, the base station device 101 transmits, to the terminal device 102, information designating at least either the time slots in which the first allocation pattern is to be used or the time slots in which the second allocation pattern is to be used. Then, upon receiving such information, the terminal device 102 set, based on the information, the allocation pattern to be used in each time slot when performing communication.

For example, using downlink control information (DCI) in the physical downlink control channel (PDCCH), the base station device 101 can transmit, to the terminal device 102, information indicating which allocation pattern is to be used by the terminal device 102 in each time slot. For example, in the case where the terminal device 102 is operating in accordance with the first allocation pattern, the base station device 101 can transmit DCI that includes information indicating the time slots in which the second allocation pattern is to be used. For example, when transmitting user data on the physical downlink shared channel (PDSCH), the base station device 101 can include, in the DCI for the PDCCH that is transmitted together with the user data, information indicating that the second allocation pattern is to be used in the time slot immediately after (or two places after) the time slot in which the PDSCH is transmitted. The base station device 101 designates, in the DCI, the frequency resource to be used by the terminal device 102 in order to return an acknowledgment response, within the frequency resource corresponding to the second allocation pattern. The terminal device 102 can therefore receive downlink user data in accordance with the first allocation pattern and transmit an uplink acknowledgment response in accordance with the second allocation pattern.

For example, the base station device 101 can notify the timing at which the terminal device 102 is to operate in accordance with the second allocation pattern. As on example, the base station device 101 can notify the terminal device 102 of the time slot numbers in which the second allocation pattern is to be used. Note that the base station device 101 can notify the terminal device 102 of all of the time slot numbers in which the second allocation pattern is to be used in a predetermined period, and accordingly, the terminal device 102 can operate based on the second allocation pattern in the notified time slots, and can operate based on the first allocation pattern in the other time slots. Also, the base station device 101 may notify the terminal device 102 of information indicating the time slots in which the terminal device 102 is to switch from the first allocation pattern to the second allocation pattern and the time slots in which the terminal device 102 is to switch back from the second allocation pattern to the first allocation pattern. Furthermore, the base station device 101 may notify a timing offset between the time slot in which the DCI is transmitted and the time slot in which a signal is to be transmitted in accordance with the second allocation pattern. For example, the base station device 101 notifies the terminal device 102 of the information “1” in the case where the second allocation pattern is to be used in the time slot immediately after the time slot in which the DCI is transmitted, or the information “2” in the case where the second allocation pattern is to be used in the time slot two places after the time slot in which the DCI is transmitted. Furthermore, the DCI that the base station device 101 transmits to the terminal device 102 may further include information indicating the timing at which the terminal device 102 is to return to the first allocation pattern. According to the methods using the DCI, the allocation pattern can be switched dynamically and in a detailed manner, thus enabling the base station device 101 to cause the terminal device 102 to flexibly execute uplink and downlink communication in accordance with the type of communication or the like.

Furthermore, the base station device 101 may notify the terminal device 102 of the allocation pattern to be used in each time slot using a radio resource control (RRC) message. For example, information indicating which of a plurality of allocation patterns is to be used in each time slot included in a frame is included in an RRC message and transmitted to the terminal device 102. For example, index numbers may be allocated to the allocation patterns in advance, and a sequence of the index numbers to be used in the time slots can be transmitted to the terminal device 102. Also, the allocation patterns that can be used by the terminal device 102 (used in the base station device 101) may be included in the RRC message. Information indicating which of the usable allocation patterns is to be used in each time slot can be included in the RRC message and notified to the terminal device 102. For example, a configuration is possible in which a maximum of two usable allocation patterns are designated, and a bitmap in which the allocation pattern to be used in each time slot is indicated by one bit can be transmitted to the terminal device 102. In the case where the allocation pattern to be used in each time slot is notified using an RRC message, the terminal device 102 can perform communication while switching between the allocation patterns in accordance with the configuration indicated in the RRC message, without needing any further instruction from the base station device 101 in particular. Note that the terminal device 102 can maintain the applied configuration until the configuration is changed using a further RRC message, for example. As yet another example, if the allocation pattern is to be changed in a portion of the time slots as an exceptional case, the base station device 101 can designate the allocation patterns that are to be used in such time slots using the above-mentioned DCI.

Furthermore, the base station device 101 can use a random access procedure to designate the allocation patterns to be used in the terminal device 102 before connection. For example, the system information block (SIB) is used to notify the timing at which Message 1 of the random access procedure can be transmitted. In this case, the base station device 101 can include, in the SIB, information designating that the above-described second allocation pattern is to be used at the timing when Message 1 can be transmitted, and that the first allocation pattern is to be used to transmit Message 2 in the time slot immediately thereafter or two places thereafter. For example, in the case where the first time slot in FIG. 2 is the time slot in which Message 1 can be transmitted, the base station device 101 can include, in the transmitted SIB, information indicating that the second allocation pattern is to be used in the first time slot, and that the first allocation pattern is to be used in the second time slot. Also, the base station device 101 may include, in the transmitted SIB, information further indicating that the second allocation pattern is to be used in the third time slot, and that the first allocation pattern is to be used in the fourth time slot, such that Message 3 and Message 4 are transmitted and received in such time slots. According to this configuration, the transmission and reception of Messages 1 to 4 of the random access procedure can be completed using as few as four time slots. Note that the allocation patterns to be used in the time slots are not limited to the patterns mentioned above. In other words, the time slots in which Messages 1 to 4 are to be transmitted and received can be set as desired. Also, in consideration of coverage enhancement, based on the presumption that each message is transmitted multiple times, the allocation pattern to be used by the terminal device 102 may be set in each time slot.

The following describes an example of the configurations of the base station device 101 and the terminal device 102 that execute the above-described processing, and an example of the flow of the executed processing.

### Device Configuration

An example of the hardware configurations of the base station device 101 and the terminal device 102 will be described below with reference to FIG. 4. In one example, the base station device 101 and the terminal device 102 each include a processor 401, a ROM 402, a RAM 403, a storage device 404, and a communication circuit 405. The processor 401 is a computer that includes one or more processing circuits such as a general-purpose central processing unit (CPU) or an application-specific integrated circuit (ASIC), and executes overall device processing and the above-mentioned processing flows by reading out a program stored in the ROM 402 or the storage device 404 and executing the program. The ROM 402 is a read-only memory that stores information such as programs and various parameters related to processing executed by the base station device 101 and the terminal device 102. The RAM 403 is a random access memory that functions as a work space when the processor 401 executes a program and also stores temporary information. The storage device 404 is configured by a removable external storage device, for example. The communication circuit 405 is configured by a circuit for LTE or 5G wireless communication, for example. Note that although one communication circuit 405 is illustrated in FIG. 4, the base station device 101 and the terminal device 102 can include a plurality of communication circuits. For example, the base station device 101 and the terminal device 102 may include wireless communication circuits for LTE and 5G and a common antenna. Note that the base station device 101 and the terminal device 102 may have separate antennas for LTE and 5G. Furthermore, the base station device 101 may have a communication circuit for wired communication for communication with other base station devices or network nodes, and the terminal device 102 may have a communication circuit for communication with other wireless communication systems via a wireless LAN, for example. Note that the base station device 101 and the terminal device 102 may have separate communication circuits 405 for each frequency band that can be used, or may have a common communication circuit 405 for at least some of the frequency bands that can be used.

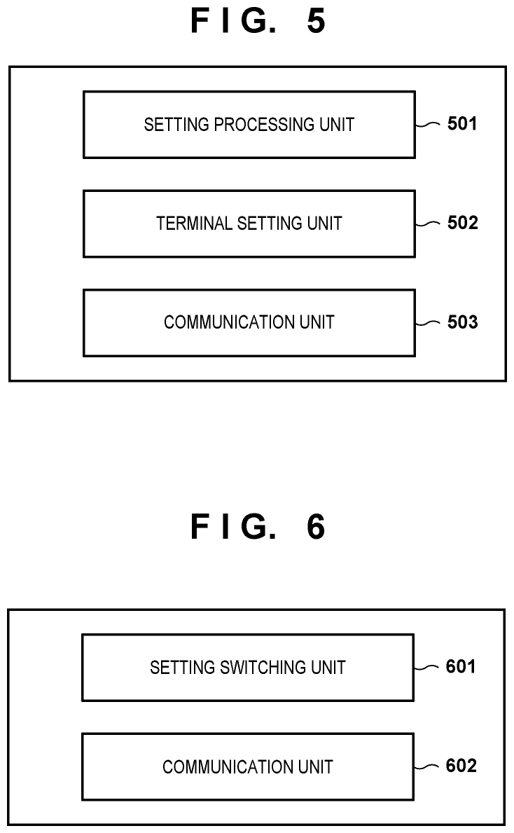

FIG. 5 is a diagram showing an example of the functional configuration of the base station device 101. The base station device 101 includes a setting processing unit 501, a terminal setting unit 502, and a communication unit 503 as functional units, for example. Note that these functional units can be realized by, for example, the processor 401 executing a program stored in the ROM 402 or the storage device 404.

The setting processing unit 501 allocates time slots to the uplink or the downlink for each frequency resource in a frequency band that can be used by the base station device 101 (e.g., a frequency band in which the terminal device 102 performs reception processing including Fourier transform all together). In the present embodiment, it is assumed that the setting processing unit 501 sets a plurality of allocation patterns in a usable frequency band, as shown in FIG. 2.

The terminal setting unit 502 sets which of the allocation patterns set by the setting processing unit 501 is to be used by the terminal device 102 in each time slot. For example, as described above, the terminal setting unit 502 uses DCI, an RRC message, an SIB, or the like to transmit, to the terminal device 102, information that can specify which of the allocation patterns is to be used in each time slot, thus performing such setting in the terminal device 102. Note that, as one example, the terminal setting unit 502 may notify a setting regarding the time slots and the corresponding allocation patterns in advance, and notify the terminal device 102 of information indicating whether or not such setting is to be enabled. As another example, a configuration is possible in which the terminal device 102 is notified, in advance, of a plurality of settings each indicating a relationship between the time slots and corresponding allocation patterns, and the terminal setting unit 502 notifies the terminal device 102 of information indicating which of the settings is to be used. Also, relationships between the time slots and corresponding allocation patterns may be stored in the terminal device 102 in advance (e.g., at the time of manufacturing or when connecting to another base station device). In this case, the terminal setting unit 502 does not need to notify the terminal device 102 of information indicating the relationship between the time slots and allocation patterns.

The communication unit 503 performs communication in accordance with the pattern of allocation of time slots to the uplink and downlink in each frequency resource, which is set by the setting processing unit 501. Note that in the case where the terminal setting unit 502 performs setting such that the connected terminal device 102 switches between a plurality of allocation patterns, the communication unit 503 performs communication with the terminal device 102 in accordance with the setting.

FIG. 6 is a diagram showing an example of the functional configuration of the terminal device 102. The terminal device 102 includes a setting switching unit 601 and a communication unit 602 as functional units, for example. Note that these functional units can be realized by, for example, the processor 401 executing a program stored in the ROM 402 or the storage device 404.

The setting switching unit 601 switches the allocation pattern to be used in units of time slots based on an instruction from the base station device 101. The setting switching unit 601 specifies which allocation pattern is to be used in each time slot based on a notification received using DCI, an RRC message, a SIB, or the like, and performs setting such that communication is performed using the specified pattern. The communication unit 602 executes communication with the base station device 101 in each time slot in accordance with the allocation pattern set by the setting switching unit 601.

### Processing Flow

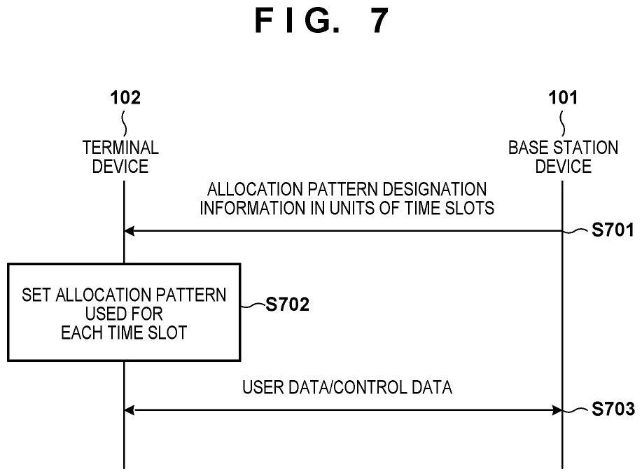

An overview of examples of flows of processing executed in the base station device 101 and the terminal device 102 will be described with reference to FIG. 7. Note that the details of the processing described here can be understood from the descriptions given above, and therefore descriptions of such details will not be repeated here.

The base station device 101 transmits, to the terminal device 102, information designating which allocation patterns are to be used by the terminal device 102 in units of time slots (step S701). For each time slot, the terminal device 102 sets the allocation pattern to be used based on the information (step S702), and performs communication of user data and control data with the base station device 101 in accordance with the setting (step S703).

According to the above configuration, the terminal device 102 can flexibly perform uplink communication and downlink communication, and communication delay can be shortened.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A terminal device comprising:
one or more processors; and
one or more memories that stores a computer-readable instruction for causing, when executed by the one or more processors, the one or more processors to function as:
a setting unit configured to perform setting so that a timeslot allocation is switched, in units of time slots, between a first allocation and a second allocation different from the first allocation, the first allocation and the second allocation being allocation of a time slot in which uplink communication is performed and a time slot in which downlink communication is performed in time division duplex (TDD) communication; and
a communication unit configured to perform communication with a base station device based on the setting.

2. The terminal device according to claim 1,
wherein the communication unit receives, from the base station device, information designating at least one of a time slot in which the first allocation is to be used and a time slot in which the second allocation is to be used, and
the setting unit performs the setting based on the information.

3. The terminal device according to claim 2,
wherein the information is transmitted from the base station device using downlink control information.

4. The terminal device according to claim 2,
wherein the information is transmitted from the base station device using a radio resource control (RRC) message.

5. The terminal device according to claim 2,
wherein the information is transmitted from the base station device using a system information block.

6. A base station device comprising:
one or more processors; and
one or more memories that stores a computer-readable instruction for causing, when executed by the one or more processors, the one or more processors to function as:
a setting unit configured to perform setting of a terminal device so that a timeslot allocation is switched, in units of time slots, between a first allocation and a second allocation different from the first allocation, the first allocation and the second allocation being allocation of a time slot in which uplink communication is performed and a time slot in which downlink communication is performed in time division duplex (TDD) communication; and
a communication unit configured to perform communication with the terminal device based on the setting.

7. The base station device according to claim 6,
wherein the setting unit performs the setting by transmitting, to the terminal device, information designating at least one of a time slot in which the first allocation is to be used and a time slot in which the second allocation is to be used.

8. The base station device according to claim 7,
wherein the setting unit transmits the information using downlink control information (DCI).

9. The base station device according to claim 7,
wherein the setting unit transmits the information using a radio resource control (RRC) message.

10. The base station device according to claim 7,
wherein the setting unit transmits the information using a system information block.

11. A communication method executed by a terminal device, comprising:
performing setting so that a timeslot allocation is switched, in units of time slots, between a first allocation and a second allocation different from the first allocation, the first allocation and the second allocation being allocation of a time slot in which uplink communication is performed and a time slot in which downlink communication is performed in time division duplex (TDD) communication; and
performing communication with a base station device based on the setting.

12. A communication method executed by a base station device, comprising:
performing setting of a terminal device so that a timeslot allocation is switched, in units of time slots, between a first allocation and a second allocation different from the first allocation, the first allocation and the second allocation being allocation of a time slot in which uplink communication is performed and a time slot in which downlink communication is performed in time division duplex (TDD) communication; and
performing communication with the terminal device based on the setting.

13. A non-transitory computer-readable storage medium that stores a program for causing a computer included in a terminal device to:
perform setting so that a timeslot allocation is switched, in units of time slots, between a first allocation and a second allocation different from the first allocation, the first allocation and the second allocation being allocation of a time slot in which uplink communication is performed and a time slot in which downlink communication is performed in time division duplex (TDD) communication; and
perform communication with a base station device based on the setting.

14. A non-transitory computer-readable storage medium that stores a program for causing a computer included in a base station device to:
perform setting of a terminal device so that a timeslot allocation is switched, in units of time slots, between a first allocation and a second allocation different from the first allocation, the first allocation and the second allocation being allocation of a time slot in which uplink communication is performed and a time slot in which downlink communication is performed in time division duplex (TDD) communication; and
perform communication with the terminal device based on the setting.
